(19) United States
(12) Patent Application Publication
(10) Pub. No.: US 2026/0104071 A1
(43) Pub. Date: Apr. 16, 2026

(54) Rod End Made of Thermoplastic Fiber-Reinforced Plastic

(71) Applicant: Albany Engineered Composites, Inc., Rochester, NH (US)

(72) Inventors: Volker Schimmelpfennig, Kaiserslautern (DE); Julian Weber, Wolfstein (DE); Martin Welsch, Henschtal (DE)

(73) Assignee: Albany Engineered Composites, Inc., Rochester, NH (US)

(21) Appl. No.: 19/418,724

(22) Filed: Dec. 12, 2025

Related U.S. Application Data
(63) Continuation-in-part of application No. 18/913,759, filed on Oct. 11, 2024.
Application No. 18/913,759 is a continuation of application No. 18/139,642, filed on Apr. 26, 2023, now Pat. No. 12,117,040.
Application No. 18/139,642 is a continuation-in-part of application No. 16/907,659, filed on Jun. 22, 2020, now Pat. No. 11,649,850.

(30) Foreign Application Priority Data
Jun. 23, 2019 (DE) 10 2019 004341.3

(51) Int. Cl. F16C 11/06; F16B 7/18; F16C 7/02; F16D 1/06

(52) U.S. Cl. CPC F16C 11/0614; F16C 7/026; F16D 1/06; F16B 7/18; F16C 2208/02; F16C 2208/36; F16C 2208/40; F16C 2208/52; F16C 2208/60; F16C 2208/76

(57) ABSTRACT

Various implementations of a clevis may include a continuous fiber reinforced thermoplastic that may be least partially looped around a first opening in the clevis and a second opening in the clevis. Implementations of a clevis may include a stem and the continuous fiber reinforced thermoplastic may extend into the stem.

### CROSS-REFERENCE TO RELATED APPLICATION

This application is a continuation-in-part application of U.S. application Ser. No. 18/913,759, filed Oct. 11, 2024, which application is a continuation application of U.S. application Ser. No. 18/139,642, filed Apr. 26, 2023, which application is a continuation-in-part of U.S. application Ser. No. 16/907,659, filed Jun. 22, 2020, which claims the benefit of priority under 35 USC § 119 of German Application No. 10 2019 004341.3, filed Jun. 23, 2019. The foregoing applications are incorporated herein by reference in their entirety.

### FIELD OF THE INVENTION

The present invention relates generally to a rod end made of thermoplastic fiber-reinforced plastic that extends, at least partially, around a bearing.

### BACKGROUND

Fiber-reinforced plastics are fiber-reinforced materials in which fibrous substances are incorporated into a plastic. They are distinguished by properties including, e.g., high stiffness and strength with comparatively low weight.

In aerospace technology, as in almost no other field of engineering, lightweight design is of preeminent importance. Consequently, innovative lightweight design concepts are especially critical for the competitiveness of many aerospace components.

Rod ends, for example in passenger and cargo aircraft, are made predominantly of metallic materials such as steel, aluminum, and titanium. The use of fiber-reinforced plastics, in particular glass fiber and carbon fiber reinforced plastics, makes it possible to achieve significant weight and/or cost savings due to the great number of such rod ends in an airplane.

Rod ends made of plastic are already known from the prior art.

DE 1,995,788 U discloses a rod end with a plain bushing and threaded stem, wherein the plain bushing and the upper end of the threaded stem are surrounded by a plastic body produced as a single piece in an injection molding process.

A spherical plain bearing is known from DE 196 15 872 A1, of which the bearing socket and bearing body are both made of plastic, and which has, in one of its embodiments, a molded-on threaded stem.

The known rod ends made of plastic offer a significant weight saving as compared with metallic rod ends. A disadvantage in these designs is the relatively low strength of plastics and short fiber reinforced plastics, for which reason only relatively small loads can be transmitted with rod ends made of plastic.

### SUMMARY OF THE INVENTION

Implementations of a clevis may include a fiber reinforced plastic at least partially looped around a first opening in the clevis and a second opening in the clevis and a stem. The fiber reinforced plastic may extend into the stem.

Implementations of a clevis may include one, all, or any of the following:

A fiber reinforced plastic having a first portion that extends into the stem and a second portion that extends into the stem. The first portion may be directly coupled to and distinct from the second portion.

A cross section of the fiber reinforced plastic in the stem may form a cross.

A cross section of the fiber reinforced plastic in the stem may form a square.

A continuous-fiber reinforced ring may encircle the fiber reinforced plastic.

The continuous-fiber reinforced ring may contact the fiber reinforced plastic.

A second plastic may encircle the continuous-fiber reinforced ring.

The continuous-fiber reinforced ring may be coupled around an outer surface of the stem.

Implementations of a clevis may include a first opening, a second opening, a fiber reinforced first plastic at least partially looped around the first opening and the second opening, a stem, and a ring encircling a portion of the fiber reinforced plastic that extends into the stem.

Implementations of a clevis may include one, all, or any of the following:

A plastic may surround the fiber reinforced plastic. The plastic may form an outer surface of the clevis.

The plastic may encapsulate the ring.

The ring may be coupled around an outer surface of the stem.

The ring may be a continuous-fiber reinforced ring and may have fibers oriented in a circumferential direction.

The continuous-fiber reinforced ring may contact the fiber reinforced plastic.

The fiber reinforced plastic may be exposed within the first opening and the second opening.

Implementations of a clevis may include: a first opening, a second opening, a first fiber reinforced plastic at least partially looped around the first opening and extending into a stem of the clevis, a second fiber reinforced plastic at least partially looped around the second opening and extending into the stem of the clevis. The first fiber reinforced plastic may be distinct from the second fiber reinforced plastic and may be directly coupled to the second reinforced plastic.

Implementations of a clevis may include one, all, or any of the following:

A ring may be coupled to the stem and may encircle the first fiber reinforced plastic and the second fiber reinforced plastic.

The ring may be exposed on an outer surface of the clevis.

The ring may be directly coupled to the first fiber reinforced first plastic and the second fiber reinforced plastic.

A locking pin may be coupled to the stem.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

FIG. 1 illustrates a side cross-sectional view of a rod end (1) according to the invention with a threaded stem (2) and comprising a continuous-fiber reinforced composite material with thermoplastic matrix (3) in the form of a loop that partially surrounds a bearing (4), and a short-fiber reinforced, long-fiber reinforced, or unreinforced thermoplastic (5). The thermoplastic (5) fully surrounds the loop of fiber-reinforced thermoplastic (3) into the threaded stem (2). The short-fiber reinforced, long-fiber reinforced, or unreinforced thermoplastic (5) defines the outer contour of the rod end (1). The continuous-fiber reinforced composite material with thermoplastic matrix (3) is implemented in four layers in this representation.

FIG. 2 illustrates a side cross-sectional view of a rod end (1) according to the invention with a threaded stem (2) and comprising a continuous-fiber reinforced composite material with thermoplastic matrix (3) in the form of a loop, which fully surrounds a bearing (4) multiple times, and a short-fiber reinforced, long-fiber reinforced, or unreinforced thermoplastic (5). The thermoplastic (5) fully surrounds the loop of fiber-reinforced thermoplastic (3) into the threaded stem (2). The short-fiber reinforced, long-fiber reinforced, or unreinforced thermoplastic (5) defines the outer contour of the rod end (1).

FIG. 3 illustrates a side cross-sectional view of a rod end (1) according to the invention with a threaded stem (2) and comprising a continuous-fiber reinforced composite material with thermoplastic matrix (3) in the form of a loop, which fully surrounds a bearing (4) multiple times, and a short-fiber reinforced, long-fiber reinforced, or unreinforced thermoplastic (5), which also secures the bearing (4) axially on its lateral surfaces. The thermoplastic (5) fully surrounds the loop of fiber-reinforced thermoplastic (3) into the threaded stem (2). The short-fiber reinforced, long-fiber reinforced, or unreinforced thermoplastic (5) defines the outer contour of the rod end (1).

FIG. 4 illustrates a side view of a rod end (1) according to the invention with threaded stem (2) and a bearing (4).

FIG. 5 illustrates a side cross-sectional view of a rod end (1) according to the invention with a threaded stem (2) and comprising a continuous-fiber reinforced composite material with thermoplastic matrix (3) in the form of a loop that surrounds a bearing (4), and a short-fiber reinforced, long-fiber reinforced, or unreinforced thermoplastic (5), built into a connecting rod with an internal thread (7) and secured by a lock washer (9) and a lock nut (8). The thermoplastic (5) fully surrounds the loop of fiber-reinforced thermoplastic (3) into the threaded stem (2). The short-fiber reinforced, long-fiber reinforced, or unreinforced thermoplastic (5) defines the outer contour of the rod end (1).

FIG. 6 illustrates a cross-sectional view of a thread profile (6) according to the invention made of short-fiber reinforced, long-fiber reinforced, or unreinforced thermoplastic (5) and a continuous-fiber reinforced composite material with thermoplastic matrix (3), wherein the continuous-fiber reinforced composite material with thermoplastic matrix (3) extends along the thread flanks.

FIG. 7 illustrates a side cross-sectional view of a rod end (1) according to the invention in the form of a clevis, comprising a bearing (4), and threaded stem (2) with, shown in dashed lines, an internal, continuous-fiber reinforced composite material with thermoplastic matrix (3) in the form of a loop, and a short-fiber reinforced, long-fiber reinforced, or unreinforced thermoplastic (5). The thermoplastic (5) fully surrounds the loop of fiber-reinforced thermoplastic (3) into the threaded stem (2). The short-fiber reinforced, long-fiber reinforced, or unreinforced thermoplastic (5) defines the outer contour of the rod end (1). The continuous-fiber reinforced composite material with thermoplastic matrix (3) is implemented in three layers in this representation.

FIG. 8 illustrates a cross-sectional view of the rod end (1) of FIG. 7, rotated by 90°.

FIG. 9 illustrates a side cross-sectional view of a rod end (1) of the invention having a ring (10) encircling a continuous-fiber reinforced composite material with thermoplastic matrix (3) in the form of a loop.

FIG. 10 illustrates a cross-sectional view of a stem of a rod end of the invention having a ring (10) that encircles a continuous-fiber reinforced composite material with thermoplastic matrix (3) and short-fiber reinforced, long-fiber reinforced, or unreinforced thermoplastic (5).

FIG. 11 illustrates a cross-sectional view of a stem of a rod end of the invention having a ring (10) that encircles a continuous-fiber reinforced composite material with thermoplastic matrix (3) and short-fiber reinforced, long-fiber reinforced, or unreinforced thermoplastic (5). The short-fiber reinforced, long-fiber reinforced, or unreinforced thermoplastic (5) also surrounds the ring (10) such that the short-fiber reinforced, long-fiber reinforced, or unreinforced thermoplastic (5) encapsulates the ring (10).

FIG. 12 illustrates a side cross-sectional sectional view of a rod end (1) of the invention with a threaded stem (2) having a ring (10) that encircles a continuous-fiber reinforced composite material with thermoplastic matrix (3) in the form of a loop. In the threaded stem (2), the continuous-fiber reinforced composite material (3) has a shape that enables a form fit (11) and maintains a constant or nearly constant cross-sectional area.

FIG. 13 illustrates an isometric view of an interior part of an unfinished stem of a rod end of the invention. The interior part is a continuous-fiber reinforced plastic component having a composite material with a form fit shape (11) while maintaining a constant or nearly constant cross-sectional area.

FIG. 14 illustrates a first implementation of a reinforced clevis device.

FIG. 15 illustrates a cross sectional view of a second implementation of a clevis device.

FIG. 16 illustrates a cross sectional view of a third implementation of a clevis device.

FIG. 17 illustrates a cross sectional view of a fourth implementation of a clevis device.

FIG. 18 illustrates a cross sectional view of a fifth implementation of a clevis device.

FIG. 19 illustrates a cross sectional view of a sixth implementation of a clevis device.

FIG. 20 illustrates a cross sectional view of a seventh implementation of a clevis device.

FIG. 21 illustrates a top, cross sectional view of the reinforced clevis device of FIG. 15.

FIG. 22 illustrates a top, cross sectional view of an eighth implementation of a reinforced clevis device.

FIG. 23 illustrates a cross sectional view of a first implementation of a stem of a reinforced clevis device.

FIG. 24 illustrates a cross sectional view of a second implementation of a stem of a reinforced clevis device.

FIG. 25 illustrates a cross sectional view of a third implementation of a stem of a reinforced clevis device.

FIG. 26 illustrates a cross sectional view of a fourth implementation of a stem of a reinforced clevis device.

FIG. 27 illustrates a first portion of a continuous fiber reinforced thermoplastic form fit core.

FIG. 28 illustrates a partial, perspective view of a reinforced clevis device.

### DETAILED DESCRIPTION

The terms “comprising” and “comprises” in this disclosure can mean “including” and “includes” or can have the meaning commonly given to the term “comprising” or “comprises” in U.S. Patent Law. Terms “consisting essentially of” or “consists essentially of” if used in the claims have the meaning ascribed to them in U.S. Patent Law. Other aspects of the invention are described in or are obvious from (and within the ambit of the invention) the following disclosure.

The present invention solves the problems of the prior art by providing a rod end that has a low weight as compared with metallic rod ends while also being able to transmit high mechanical loads, unlike prior plastic rod ends, and can also be manufactured economically.

In certain embodiments, a rod end according to the present invention may be an attachment element for introducing tensile and compressive forces into various connecting rods, for example, for applications in the aviation field.

The rod end according to the present invention is also suitable for many other applications, in particular for the transmission of tensile and compressive forces, for guidance and mechanical mounting, and for supporting various connections or braces.

Conventional rod ends can be made from metal or plastic, but these have disadvantages such as high weight or inability to transmit high mechanical loads, respectively. In one aspect, the instant invention provides a rod end with a low weight in comparison to metallic rod ends and an ability to transmit high mechanical loads unlike conventional plastic rod ends, for example, as used in the aerospace and aviation fields.

In certain embodiments, the present invention achieves a high mechanical load capacity of a rod end by means of a loop that passes around a spherical plain bearing or a bushing and that is made of fiber-reinforced plastic. In certain embodiments, the fiber-reinforced plastic is a continuous-fiber reinforced composite material with thermoplastic matrix, such as a unidirectional continuous-fiber reinforced composite material with thermoplastic matrix. A fiber-reinforced plastic in which a fiber content of over 80% extends in the longitudinal direction of a fiber-reinforced plastic component of a rod end of the invention is referred to herein as a unidirectional fiber-reinforced plastic. A continuous fiber may be a single fiber or a bundle of fibers that originate in, e.g., a threaded stem of a rod end of the instant invention, wrap around a bearing or bushing in the rod end, and then terminate in the stem of the rod end. A continuous fiber is in contrast to a discontinuous fiber, such as a chopped fiber or broken stretched carbon fiber.

The present invention further concerns components comprising a fiber-reinforced plastic, such as a continuous-fiber reinforced composite material with a thermoplastic matrix. In certain embodiments, one or more fibers in the fiber-reinforced plastic are carbon fibers, basalt fibers, aramid fibers, plastic fibers, cotton fibers, metal fibers, glass fibers, and/or a combination thereof impregnated in plastic, such as a thermoplastic, material. In some embodiments, the fiber-reinforced plastic is made of fibers impregnated in plastic, such as a thermoplastic, material with a fiber volume fraction of at least 30%, at least 35%, at least 40%, at least 45%, at least 50%, at least 55%, at least 60%, at least 65%, at least 70%, at least 75%, at least 80%, at least 85%, or at least 90%.

In certain embodiments, a component comprising fiber-reinforced plastic, such as a continuous-fiber reinforced composite material with thermoplastic matrix, extends into a threaded stem of a rod end of the invention. The threaded stem can be implemented with an external or an internal thread. All known types of internal and external thread can be used, including special thread forms that may be used as well. By way of example, round thread, trapezoidal thread, buttress thread, and triangular thread are known thread types that may be used. An external thread is one that is present on the exterior, e.g., the exterior of a stem of a rod end. Conversely, an internal thread is one that is present on the interior, e.g., the interior of a stem of a rod end.

In certain further embodiments, a short-fiber reinforced, long-fiber reinforced, or unreinforced plastic, such as thermoplastic, fully or partially surrounds the loop of fiber-reinforced plastic into the threaded stem, and fully or partially defines the outer contour of the rod end.

In some embodiments, the loop of fiber-reinforced plastic has a thermoplastic matrix, by which means the fiber reinforced plastic can form an integral connection with the short-fiber reinforced, long-fiber reinforced, or unreinforced thermoplastic.

Any suitable method for making a bearing, a fiber-reinforced plastic, and/or a short-fiber reinforced plastic, long-fiber reinforced plastic, or unreinforced plastic for use in a rod end of the invention may be employed.

Likewise, any suitable method may be used for creating an integral connection between one or more of a bearing, fiber-reinforced plastic, or short-fiber reinforced, long-fiber reinforced, or unreinforced plastic in a rod end of the invention. In certain embodiments, by way of non-limiting example, a method for making an integral connection that positions a fiber-reinforced plastic component and a bearing in a rod end of the invention may be through injection molding, such that the fiber-reinforced plastic and bearing are precisely positioned with respect to one another. In other embodiments, use of injection molding may similarly be used to create an integral connection between a fiber-reinforced plastic component and a short-fiber reinforced, long-fiber reinforced, or unreinforced thermoplastic in a rod end of the invention, such that the fiber-reinforced plastic component and surrounding thermoplastic are precisely positioned with respect to one another.

Examples of plastics that may be used for the fiber-reinforced plastic component include polypropylene (PP), polyamide (PA), acrylonitrile butadiene styrene (ABS), polyethylene imine (PEI), polyphthalamide (PPA), polyphenylene sulfide (PPS), polyaryletherketone (PAEK), polyetherketoneketone (PEKK), polyetheretherketone (PEEK), and combinations thereof.

Examples of fibers that may be used in the fiber-reinforced plastic component include carbon fibers, basalt fibers, aramid fibers, plastic fibers (including polyamide fibers, polyester fibers, polyethylene fibers and others), cotton fibers, metal fibers, glass fibers, and combinations thereof.

Examples of plastics that may be used for the short-fiber reinforced, long-fiber reinforced, and/or unreinforced plastic include: polypropylene (PP), polyamide (PA), acrylonitrile butadiene styrene (ABS), polyethylene imine (PEI), polyphthalamide (PPA), polyphenylene sulfide (PPS), polyaryletherketone (PAEK), polyetherketoneketone (PEKK), polyetheretherketone (PEEK), and combinations thereof.

Examples of fibers that may be used in the short-fiber reinforced or long-fiber reinforced plastic include carbon fibers, basalt fibers, aramid fibers, plastic fibers (including polyamide fibers, polyester fibers, polyethylene fibers and others), cotton fibers, metal fibers, glass fibers, and combinations thereof. Short fibers for use in the short-fiber reinforced plastic according to the invention typically range from 0.1 mm to 1 mm in length. Long fibers for use in the long-fiber reinforced plastic according to the invention typically range from 1 mm to 50 mm in length.

The fibers in the short-or long-fiber reinforced plastic may be oriented in any suitable direction, including unidirectional and/or random directions.

To increase the content of the fiber-reinforced plastic, such as continuous-fiber reinforced composite material with thermoplastic matrix, in a rod end of the invention, the fiber-reinforced plastic may be implemented in the rod end as multiple layers. The multiple layers may all be the same, differing, or have a varying combination of the same and differing fiber-reinforced material. In one exemplary embodiment, one layer may be a multi-directional continuous-fiber reinforced thermoplastic while two additional layers are unidirectional continuous-fiber reinforced thermoplastic.

In some embodiments, to better accommodate tensile and compressive forces, a fiber-reinforced plastic, such as a unidirectional fiber-reinforced plastic, can, in addition, fully surround a spherical plain bearing or a bushing one time or multiple times in accordance with the invention.

In certain embodiments, the instant invention includes one or more holes for accommodating a pin. Additionally, a spherical plain bearing; a bushing; and the outer ring of an articulated element, bushing, or spherical plain bearing, are also referred to herein as bearings. Generally, a bearing may support one or more components that move against each other.

In certain embodiments, the bearing comprises a metallic material, a plastic material, a fiber composite material, or a combination thereof.

In some embodiments, the present invention achieves a high mechanical load capacity of a rod end by means of a fiber-reinforced plastic, such as a continuous-fiber reinforced composite material with thermoplastic matrix, that extends in the form of a loop, at least partially, around a bearing, and where the fiber-reinforced plastic also extends into the threaded stem.

“In the form of a loop” means surrounding or encircling of a bearing by fiber-reinforced plastic, such as a continuous-fiber reinforced composite material with thermoplastic matrix, with a wrap angle of more than 160°. In certain embodiments, the wrap angle is more than 180°.

In some embodiments, the rod end comprises a ring, which may be made of continuous-fiber reinforced composite material. Use of a ring in a rod end of the invention provides increased mechanical load capacity without having to increase the rod end's outer dimensions or total weight, which are properties of high importance, for instance, in the field of aerospace components.

In certain embodiments, the ring encircles at least a portion of the fiber-reinforced (e.g., continuous-fiber reinforced) plastic component that surrounds the bearing and extends into the rod end stem. In embodiments comprising a ring, the ring is typically placed in the stem of the rod end such that the ring encircles a portion of the fiber-reinforced (e.g., continuous-fiber reinforced) plastic component that is in the rod end stem. Generally, the ring is located in the upper end of the rod end stem. In certain embodiments, the ring is located in the rod end stem just before the fiber-reinforced plastic component splits to form a loop around the bearing. In certain embodiments, the ring prevents the loop from breaking open. In some embodiments, the fiber-reinforced plastic component comprises multiple layers of continuous-fiber reinforced thermoplastic, and the ring encircles a portion of the multilayered continuous-fiber reinforced thermoplastic in the rod end stem.

In certain embodiments, the ring encircles and is in direct contact with the fiber-reinforced (e.g., continuous-fiber reinforced) plastic component. In other embodiments, the ring encircles at least a portion of the fiber-reinforced plastic component but does not directly contact the fiber-reinforced plastic component portion the ring is encircling. In embodiments where the ring does not directly contact the fiber-reinforced plastic component the ring is encircling, the ring may be connected, e.g., on its inner surface, to the fiber-reinforced first plastic component via a short-fiber reinforced, long-fiber reinforced, or unreinforced second plastic. In these embodiments, the short-fiber reinforced, long-fiber reinforced, or unreinforced second plastic contacts both the fiber-reinforced first plastic component and the ring, thereby connecting the component and ring to one another.

In some embodiments, the ring itself is enclosed by a short-fiber reinforced, long-fiber reinforced, or unreinforced thermoplastic that surrounds and is in contact with the ring. In a particular embodiment, the short-fiber reinforced, long-fiber reinforced, or unreinforced thermoplastic fully surrounds the ring and is in contact with all surfaces of the ring such that the ring is effectively encapsulated by the short-fiber-reinforced, long-fiber reinforced, or unreinforced thermoplastic.

In certain embodiments, the bearing, the fiber-reinforced first plastic component, and/or the ring is at least partially enclosed by the short-fiber-reinforced, long-fiber-reinforced, or unreinforced second plastic. In a particular embodiment, the bearing, the fiber-reinforced first plastic component, and the ring are all at least partially enclosed by the short-fiber-reinforced, long-fiber-reinforced, or unreinforced second plastic.

Typically, the lower end of the rod end stem is threaded. In some embodiments, the thread extends over a ring in the stem, e.g., the thread extends from the lower to upper stem end, including over the upper end of the stem where the ring may be situated. In other embodiments, the thread does not extend over a ring in the stem, e.g., the ring is located in the upper end of the stem and only the lower end of the rod end stem is threaded. In certain embodiments, fibers in the fiber-reinforced plastic component conform to a thread profile adjacent to a surface of the threaded stem. In certain embodiments, a ring is in the upper end of the stem and fibers in the fiber-reinforced plastic component conform to a thread profile that is in the lower end of the rod end stem.

In embodiments where the rod end comprises a ring, the ring diameter may be the same diameter as the rod end stem diameter. In embodiments where the ring forms an outer contour of the rod end stem, the short-fiber-reinforced, long-fiber-reinforced, or unreinforced plastic does not encapsulate the ring. Rather, if in contact with the ring in this embodiment, the short-fiber-reinforced, long-fiber-reinforced, or unreinforced plastic contacts one or more sides of the ring that do not form an outer contour of the rod end stem. In other embodiments, the ring diameter may be less than the stem diameter, e.g., when the ring is fully surrounded by a short-fiber-reinforced, long-fiber-reinforced, or unreinforced thermoplastic. In embodiments where the ring diameter is less than the stem diameter, the short-fiber-reinforced, long-fiber-reinforced, or unreinforced thermoplastic may form the outer contour of the rod end stem. In yet other embodiments, the ring diameter is greater than the diameter of the rod end stem, e.g., in embodiments where the ring protrudes over the stem.

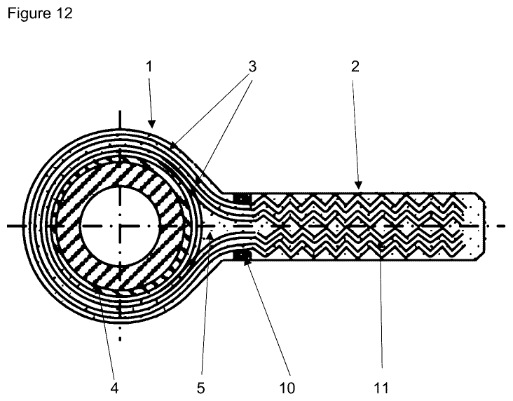

A radius of the ring may be any suitable radius. Likewise, the width of the ring may be any suitable width. In some embodiments, the ring does not extend beyond a fiber-reinforced (e.g., continuous-fiber reinforced) plastic component that is form fit in the rod end stem. See, for example, the embodiment depicted in FIG. 12.

In some embodiments, the ring comprises continuous-fiber reinforced material. In certain embodiments, the fibers in the continuous-fiber reinforced material of the ring are circumferential fibers.

Examples of suitable compounds that may be used to make a ring for use in a rod end of the invention include polypropylene (PP), polyamide (PA), acrylonitrile butadiene styrene (ABS), polyethylene imine (PEI), polyphthalamide (PPA), polyphenylene sulfide (PPS), polyaryletherketone (PAEK), polyetherketoneketone (PEKK), polyetheretherketone (PEEK), and combinations thereof. Likewise, the ring may comprise epoxy resin or any other suitable thermoset material. In some embodiments, the ring comprises a metallic material. In certain embodiments, the ring comprises any kind of steel or aluminum alloy, and combinations thereof.

Examples of fibers that may be used in a continuous-fiber reinforced ring include carbon fibers, basalt fibers, aramid fibers, plastic fibers (including polyamide fibers, polyester fibers, polyethylene fibers and others), cotton fibers, metal fibers, glass fibers, and combinations thereof.

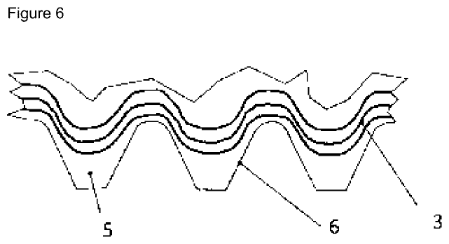

In certain embodiments, the fiber-reinforced plastic component in the threaded stem strengthens the rod end against a breaking away of the threaded stem. In addition, in further embodiments, a course of fibers, such as continuous fibers, conforms to a thread profile near the surface of the threaded stem in a shape projected by the fibers into the thread ridges, e.g., as in FIG. 6, and strengthens the threaded stem against shearing off of the thread ridges. For example, in certain embodiments, the fibers are continuous fibers that conform to a thread profile near the surface of a threaded stem. FIG. 6 shows where continuous fibers have conformed to the thread ridges of the threaded stem shape. By having the continuous fibers conform to the profile near the surface of the threaded stem, the threaded stem is strengthened against shearing off of the thread ridges.

Additionally, in certain embodiments, the fiber-reinforced (e.g., continuous-fiber reinforced) plastic component has a shape that enables a form fit. For example, in certain embodiments, the fiber-reinforced plastic component comprises a composite material that may be shaped into a form fit in the stem of a rod end of the invention. Thus, in some embodiments, the fiber-reinforced plastic component extends into the threaded stem of the rod end and is shaped to enable a form fit in the stem. In further embodiments, the fiber-reinforced plastic component is wrapped, at least partially, one or more times around a bearing or bushing in the rod end and is shaped into a form fit in the threaded stem of the rod end. In some embodiments, the fiber-reinforced first plastic component is form fit with a short-fiber-reinforced, long-fiber-reinforced, or unreinforced second plastic material. In embodiments where the fiber-reinforced first plastic component is form fit with a short-fiber-reinforced, long-fiber-reinforced, or unreinforced second plastic, there is typically positive locking between the two plastics. The positive locking can be achieved by shaping each plastic such that, e.g., the two plastics have complementary shapes (e.g., complementary undercuts on each plastic) that fit and lock each plastic to one another in the rod end stem.

The form fit configuration could be any suitable shape and configuration. In some embodiments, the form fit comprises a configuration comprising one or more angled shapes. In other embodiments, the form fit configuration comprises one or more curved shapes. In yet other embodiments, the form fit configuration comprises both angled and curved shapes.

In other embodiments, the form-fitting fiber-reinforced first plastic component maintains a constant or nearly constant cross-sectional area in the threaded stem. The constant cross-sectional area enables production from continuous-fiber reinforced semi-finished products, such as, for example, unidirectional fiber-reinforced thermoplastic tape material (UD-Tapes) or unidirectional fiber-reinforced composite profiles (UD-Profiles). As a result, the fiber volume content in the continuous-fiber reinforced first plastic component part is consistent, and the fibers are continuous without being cut, an advantage since cutting fibers weakens the finished rod end.

A fiber-reinforced (e.g., continuous-fiber reinforced) plastic component with a form fit in the rod end stem also allows for, e.g., an increased mechanical load capacity of the rod end without having to increase its outer dimensions or total weight, properties important, for instance, in the field of aerospace components.

To accommodate forces that act axially, a bearing, such as a spherical plain bearing or bushing, can also be partially or fully secured in a positive-locking manner by short-fiber reinforced, long-fiber reinforced, or unreinforced thermoplastic over one or more lateral surfaces or contours introduced into the bearing, e.g., the spherical plain bearing or bushing.

In some embodiments, a continuous-fiber reinforced first plastic component, such as a form-fit plastic component, is surrounded by a second plastic that is a short-fiber reinforced, long-fiber reinforced, or unreinforced thermoplastic that also provides a thread on the surface of the stem, e.g., by placing the continuous-fiber reinforced first plastic component together with a bearing and in certain embodiments, a ring, in a mold in an injection molding machine and injecting the second plastic into the mold such that the second plastic surrounds the first plastic component, bearing, and ring to form the outer contour of the rod end and provide the thread in the rod end stem. In embodiments where the ring is the same diameter as the rod end stem, the ring forms a contour of the rod end stem coincident with a contour formed by the second plastic in the rod end stem.

Generally, rod ends are used in an extremely wide variety of sizes and in high quantities. In certain embodiments of the invention, the inventive rod ends are in the form of clevises or swivel heads.

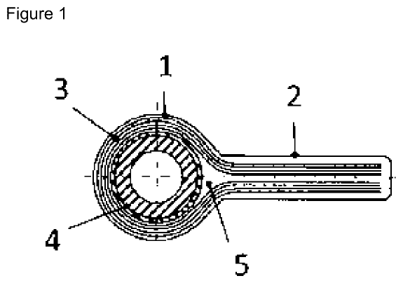

FIG. 1 illustrates a side cross-sectional view of a rod end (1) according to the invention. FIG. 1 depicts a threaded stem (2) with a bearing (4). The threaded stem (2) is adjacent to the bearing (4). The central axis of the stem (2) intersects the center of the bearing (4). A continuous-fiber reinforced material with thermoplastic matrix (3) extends into the stem (2). FIG. 1 also illustrates a continuous-fiber reinforced composite material with thermoplastic matrix (3) in the form of a loop. The continuous-fiber reinforced composite material with thermoplastic matrix (3) is a loop that partially surrounds the bearing (4). The bearing (4), however, is not exposed because the remaining “free space” is filled by a short-fiber reinforced, long-fiber reinforced, or unreinforced thermoplastic (5). The thermoplastic (5) also surrounds the fiber-reinforced thermoplastic (3) into the stem (2) and forms the outer contour of the rod end (1). The continuous-fiber reinforced composite material with thermoplastic matrix (3) is implemented in four layers in this representation.

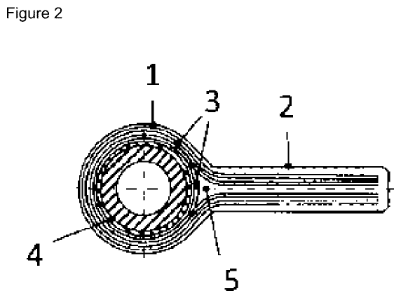

FIG. 2 illustrates a side cross-sectional sectional view of a rod end (1) according to the invention with a threaded stem (2) and comprising a continuous-fiber reinforced composite material with thermoplastic matrix (3) in the form of a loop. Here, the loop fully surrounds a bearing (4) multiple times. There is a short-fiber reinforced, long-fiber reinforced, or unreinforced thermoplastic (5) that surrounds the fiber-reinforced thermoplastic matrix (3) into the stem (2) and forms the outer contour of the rod end (1). The bearing (4) is fully surrounded by the continuous-fiber reinforced composite material with thermoplastic matrix (3).

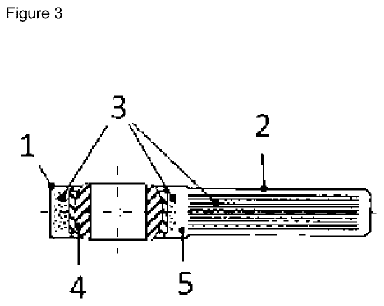

FIG. 3 illustrates a cross-sectional view of a rod end (1) according to the invention with a threaded stem (2) and comprising a continuous-fiber reinforced composite material with thermoplastic matrix (3) in the form of a loop. The continuous-fiber reinforced thermoplastic (3) fully surrounds a bearing (4) multiple times. FIG. 3 further illustrates a short-fiber reinforced, long-fiber reinforced, or unreinforced thermoplastic (5), which also secures the bearing (4) axially on the bearing's (4) lateral surfaces.

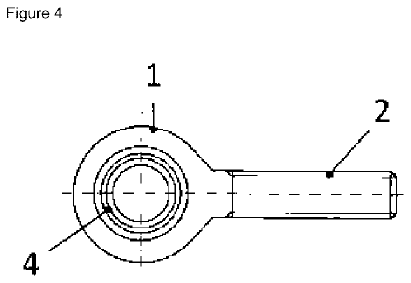

FIG. 4 illustrates a side view of the outside of a rod end (1) according to the invention with a bearing (4) and threaded stem (2). The material on the surface of the rod end (1) is made of short-fiber reinforced, long-fiber reinforced, or unreinforced thermoplastic (5). FIG. 4 further illustrates a thread of the threaded stem (2) as depicted for a technical drawing as would be appreciated by a person of ordinary skill in the art.

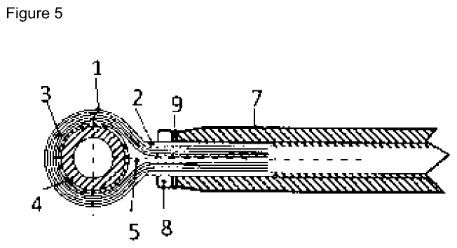

FIG. 5 illustrates a side cross-sectional view of a rod end (1) according to the invention with a threaded stem (2) and comprising a continuous-fiber reinforced composite material with thermoplastic matrix (3) in the form of a loop and a short-fiber reinforced, long-fiber reinforced, or unreinforced thermoplastic (5), built into a connecting rod with an internal thread (7) and secured by a lock washer (9) and a lock nut (8).

FIG. 6 illustrates a cross-sectional view of a thread profile (6) according to the invention made of short-fiber reinforced, long-fiber reinforced, or unreinforced thermoplastic (5) and a continuous-fiber reinforced composite material with thermoplastic matrix (3). FIG. 6 shows where the continuous-fiber reinforced composite material with thermoplastic matrix (3) extends along the thread flanks.

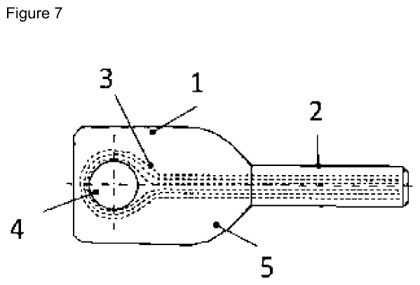

FIG. 7 illustrates a side cross-sectional view of a rod end (1) according to the invention in the form of a clevis, and comprising a bearing (4), and threaded stem (2). Shown in dashed lines is an internal continuous-fiber reinforced composite material with thermoplastic matrix (3) in the form of a loop, and a short-fiber reinforced, long-fiber reinforced, or unreinforced thermoplastic (5). The continuous-fiber reinforced composite material with thermoplastic matrix (3) is implemented in three layers in this illustration.

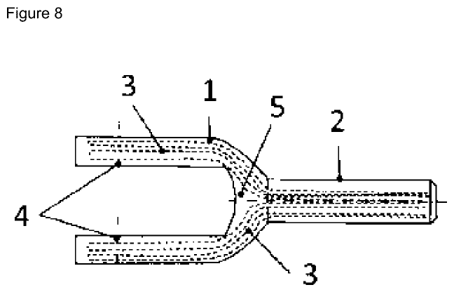

FIG. 8 illustrates a cross-sectional view of the rod end of FIG. 7, rotated by 90°.

FIG. 9 illustrates a side cross-sectional sectional view of a rod end (1) according to the invention with a threaded stem (2) and ring (10) and comprising a continuous-fiber reinforced composite material with thermoplastic matrix (3) in the form of a loop. In this embodiment, the loop fully surrounds a bearing (4) multiple times. There is a short-fiber reinforced, long-fiber reinforced, or unreinforced thermoplastic (5) that surrounds the fiber-reinforced thermoplastic matrix (3) into the stem (2) and forms an outer contour of the rod end (1). The bearing (4) is fully surrounded by the continuous-fiber reinforced composite material with thermoplastic matrix (3). A ring (10) encircles a portion of the continuous-fiber reinforced composite material with thermoplastic matrix (3) at the upper end of the threaded stem (2). FIG. 9 depicts a rod end with a swivel head.

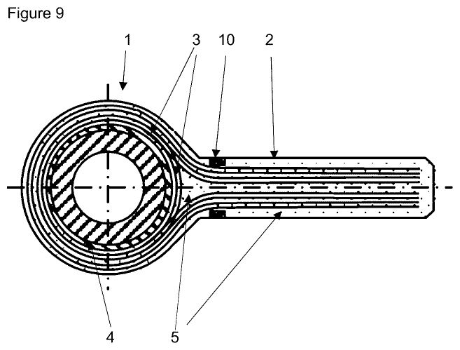

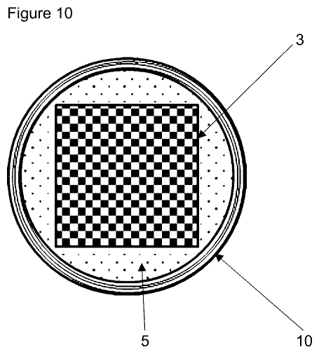

FIG. 10 illustrates a cross-sectional view of a stem of a rod end of the invention having a continuous-fiber reinforced ring (10) encircling a continuous-fiber reinforced composite material with thermoplastic matrix (3) and short-fiber reinforced, long-fiber reinforced, or unreinforced thermoplastic (5). The ring (10) forms an outer contour of the rod end stem.

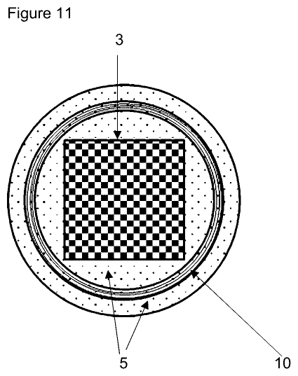

FIG. 11 illustrates a cross-sectional view of a stem of a rod end of the invention having a continuous-fiber reinforced ring (10) encircling a continuous-fiber reinforced composite material with thermoplastic matrix (3) and short-fiber reinforced, long-fiber reinforced, or unreinforced thermoplastic (5). The short-fiber reinforced, long-fiber reinforced, or unreinforced thermoplastic (5) also surrounds the continuous-fiber reinforced ring (10) and forms the outer contour of the rod end stem.

FIG. 12 illustrates a side cross-sectional sectional view of a rod end (1) according to the invention with a threaded stem (2) and a ring (10) and having a continuous-fiber reinforced composite material with thermoplastic matrix (3) in the form of a loop. The loop fully surrounds a bearing (4) multiple times. There is a short-fiber reinforced, long-fiber reinforced, or unreinforced thermoplastic (5) that surrounds the fiber-reinforced thermoplastic matrix (3) into the stem (2) and forms an outer contour of the rod end (1). The bearing (4) is fully surrounded by the continuous-fiber reinforced composite material with thermoplastic matrix (3). The ring (10) encircles a portion of the continuous-fiber reinforced composite material with thermoplastic matrix (3) in an upper portion of the threaded stem and forms an outer contour of the stem. The continuous-fiber reinforced composite material with thermoplastic matrix (3) is shaped into a form fit (11) while maintaining a constant or nearly constant cross-sectional area in the threaded stem (2). Thus, here the plastic component (3) form fits in the stem while wrapping around the bearing (4) in the other end of the rod end. The form fit of the plastic component (3) results in the continuous-fiber reinforced composite material with thermoplastic matrix (3) being in a form fit configuration with the short-fiber reinforced, long-fiber reinforced, or unreinforced thermoplastic material (5) in the rod end stem.

FIG. 13 illustrates an isometric view of an interior part of an unfinished stem of a rod end of the invention. The interior part is a continuous-fiber reinforced plastic component (3) having a composite material with a form fit shape (11) while maintaining a constant or nearly constant cross-sectional area. Generally, to become a finished stem, the form-fit first plastic component may then be surrounded by a second plastic that is a short-fiber reinforced, long-fiber reinforced, or unreinforced thermoplastic that also provides a thread on the surface of the stem, e.g., by placing the form-fit first plastic component in a mold in an injection molding machine and injecting the second plastic into the mold such that the second plastic surrounds the form-fit first plastic component to form the outer contour of the rod end stem and provide the thread.

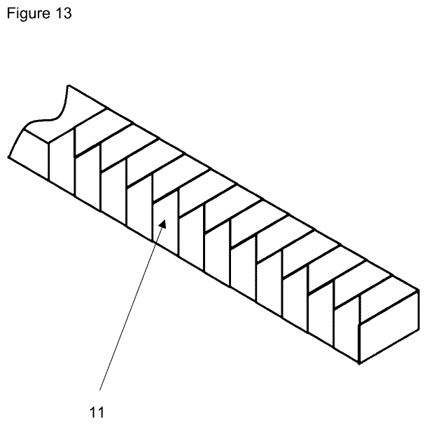

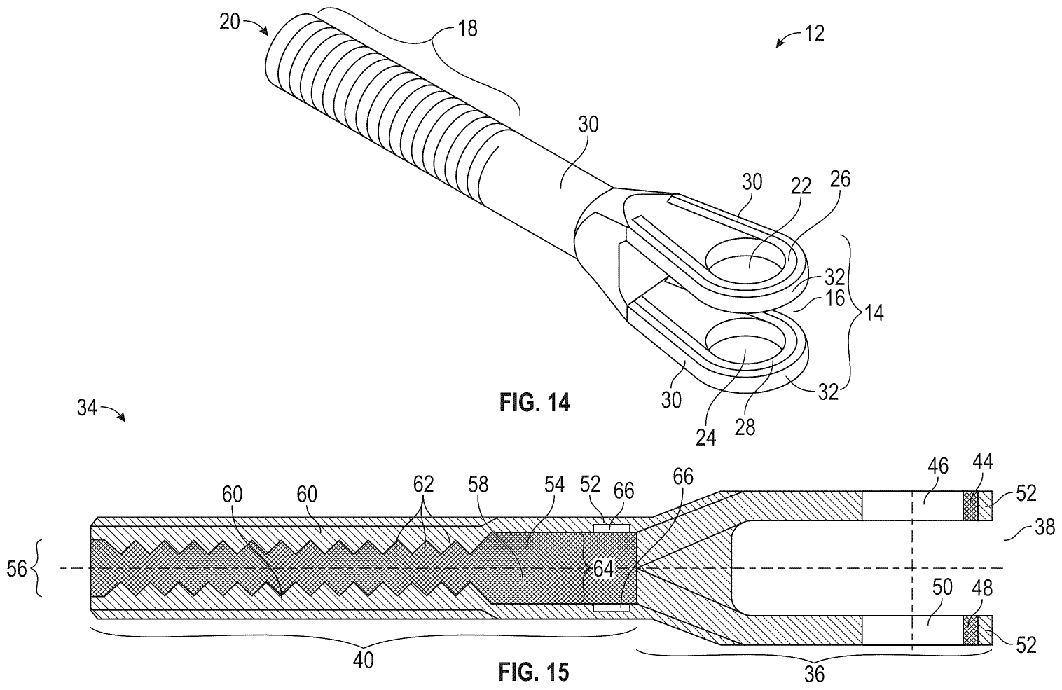

Referring to FIGS. 14-22, various implementations of reinforced clevis devices are illustrated. These implementations include commonalities and differences. Where specifics of various elements of a particular implementation are not discussed, it is understood that those elements may be the same as corresponding elements disclosed in any other implementation herein.

Referring to FIG. 14, a perspective view of an implementation of a reinforced clevis device 12 is illustrated. The reinforced clevis device 12 includes a clevis 14 at a first end 16 of the reinforced clevis device 12. The reinforced clevis device 12 includes a stem 18 at a second end 20 of the reinforced clevis device 12. In various implementations, the stem 18 may be threaded. The clevis 14 has a first opening 22 near the first end 16 of the reinforced clevis device 12 and a second opening 24 near the first end 16 of the reinforced clevis device 12.

In various implementations, a first loop 26 of continuous fiber reinforced thermoplastic partially surrounds a portion of the first opening 22 and a second loop 28 of continuous fiber reinforced thermoplastic partially surrounds a portion of the second opening 24. In such implementations, a portion of the first loop 26 may be exposed within just a portion of the first opening 22 and a portion of the second loop 28 may be exposed within just a portion of the second opening 24.

In other implementations, the first loop of continuous fiber reinforced thermoplastic may fully surround the first opening and the second loop of continuous fiber reinforced thermoplastic may fully surround the second opening. In such implementations, a portion of the first loop 26 may be exposed within the entirety of the first opening 22 and a portion of the second loop 28 may be exposed within the entirety of the second opening 24.

In various implementations, a second plastic may at least partially surround the first loop 26 of continuous fiber reinforced thermoplastic and may at least partially surround the second loop 28 of continuous fiber reinforced thermoplastic. The second plastic may be a short-fiber reinforced, long-fiber reinforced, or unreinforced thermoplastic 30 (hereinafter “thermoplastic 30”). In such implementations, the thermoplastic 30 forms an outer contour 32 of the clevis 14. In various implementations, the thermoplastic 30 may also be within a portion of the first loop 26 and the second loop 28, as illustrated by FIG. 14. The thermoplastic 30 may be exposed within a portion of the first opening 22 and a portion of the second opening 24.

Referring to FIG. 15, a side, cross sectional view of a second reinforced clevis device 34 is illustrated. The reinforced clevis device 34 may be the same as the reinforced clevis device 12, with the only distinction being that the outer surface of the stem 40 is not threaded. As illustrated by FIG. 15, the reinforced clevis device includes a clevis 36 near a first end 38 of the reinforced clevis device 34. The reinforced clevis device 34 includes a stem 40 near a second end 42 of the reinforced clevis device 34.

A first loop 44 of continuous fiber reinforced thermoplastic surrounds a portion of a first opening 46 of the clevis 36. A second loop 48 of continuous fiber reinforced thermoplastic surrounds a portion of a second opening 50 of the clevis 36.

In various implementations, a second plastic may at least partially surround the first loop of continuous fiber reinforced thermoplastic and may at least partially surround the second loop of continuous fiber reinforced thermoplastic. The second plastic may be a short-fiber reinforced, long-fiber reinforced, or unreinforced thermoplastic 52. A short-fiber reinforced, long-fiber reinforced, or unreinforced thermoplastic 52 surrounds the first loop 44 of continuous fiber reinforced thermoplastic at a first end 38 of the reinforced clevis device 34 and the second loop 48 of continuous fiber reinforced thermoplastic at a first end 38 of the reinforced clevis device 34 to form an outer contour of the clevis.

Both ends of the first loop 44 of continuous fiber reinforced thermoplastic join to form a first portion 54 of the form fit core 56 that runs through the middle of the stem 40. Both ends of the second loop 48 of continuous fiber reinforced thermoplastic join to form a second portion 58 of the form fit core 56 that runs through the middle of the stem 40.

In various implementations, the short-fiber reinforced, long-fiber reinforced, or unreinforced thermoplastic 52 surrounds the core and forms the exterior of the stem 60. As illustrated in FIG. 15, the form fit core 56 has a form fit shape with a plurality of angled projections 62 around the perimeter of the form fit core 56. In various implementations, the angled projections only extend along a portion of the length of the form fit core 56. In other implementations, the angled projections 62 may extend along an entire length of the form fit core.

In various implementations, the reinforced clevis device 34 may include a ring 66 at or near a first end of the form fit core 56. From the side view illustrated in FIG. 15, the ring 66 is positioned between the continuous fiber reinforced thermoplastic form fit core 56 and a short-fiber reinforced, long-fiber-reinforced, or unreinforced thermoplastic 52 portion of the stem 60. In such implementations, the ring is fully encapsulated within the stem and is not exposed on the outer surface of the reinforced clevis device 34. The ring 66 is configured to maintain direct contact between the first portion 54 of the form fit core 56 and the second portion 58 of the form fit core 56 during an injection molding process. In such implementations, the ring may be configured to secure the reinforced thermoplastic portions forming the form fit core in a desired position while also adding additional reinforcement to the reinforced clevis device by strengthening the stem 60.

The ring 66 may be made from any material disclosed herein.

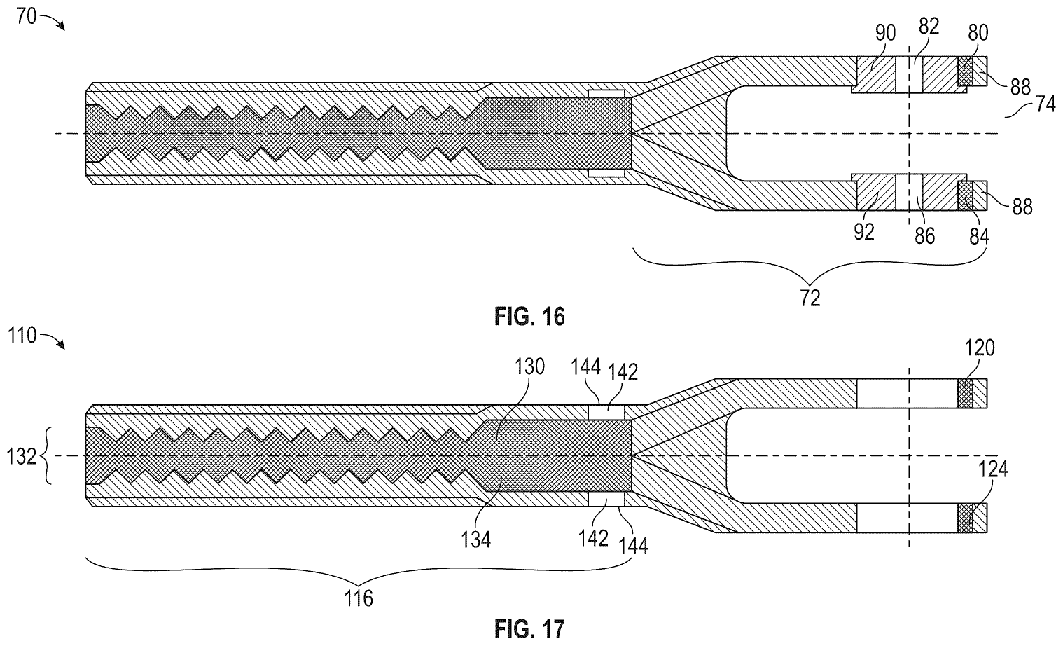

Referring to FIG. 16, a side, cross sectional view of a third implementation of a reinforced clevis device 70 is illustrated. The reinforced clevis device 70 may be the same as the reinforced clevis device 34 of FIG. 15, with the only distinction being that the reinforced clevis device 70 includes a first bushing 90 within the first opening 82 of the clevis and a second bushing 92 within the second opening 86 of the clevis.

The reinforced clevis device 70 includes a clevis 72 near a first end 74 of the reinforced clevis device 70. A first loop 80 of continuous fiber reinforced thermoplastic surrounds a portion of a first bushing 90 within of a first opening 82 of the clevis 72. A second loop 84 of continuous fiber reinforced thermoplastic surrounds a portion of a second bushing 92 within a second opening 86 of the clevis 72.

In various implementations, a second plastic may at least partially surround the first loop of continuous fiber reinforced thermoplastic and may at least partially surround the second loop of continuous fiber reinforced thermoplastic. The second plastic may be a short-fiber reinforced, long-fiber reinforced, or unreinforced thermoplastic. The short-fiber reinforced, long-fiber reinforced, or unreinforced thermoplastic forms an outer contour 88 of the clevis 72.

Referring to FIG. 17, a side, cross sectional view of a fourth implementation of a reinforced clevis device 110 is illustrated. The reinforced clevis device 110 may be the same as the reinforced clevis device 34 of FIG. 15, with the only distinction being that the ring 142 is exposed on an outer surface of the reinforced clevis device 110.

Both ends of the first loop 120 of continuous fiber reinforced thermoplastic join to form a first portion 130 of the form fit core 132 that runs through the middle of the stem 116. Both ends of the second loop 124 of continuous fiber reinforced thermoplastic join to form a second portion 134 of the form fit core 132 that runs through the middle of the stem 116.

A ring 142 is coupled around the continuous fiber reinforced thermoplastic form fit core 132 made from the first portion 130 and the second portion 134. From the side view illustrated in FIG. 17, the ring 142 is positioned against the continuous fiber reinforced thermoplastic form fit core 132 and is exposed on the exterior perimeter 144 of the stem. In various implementations, the ring is exposed around an entire outer perimeter of the stem. In other implementations, the ring may be exposed along only a portion of the outer perimeter. The ring 142 is configured to maintain direct contact between the first portion 130 of the form fit core 132 and the second portion 134 of the form fit core 132 during an injection molding process. In such implementations, the ring 142 may be configured to secure the reinforced thermoplastic portions forming the form fit core 132 in a desired position while also adding additional reinforcement to the reinforced clevis device 110 by strengthening the stem 116.

The ring 142 may be made from any material disclosed herein.

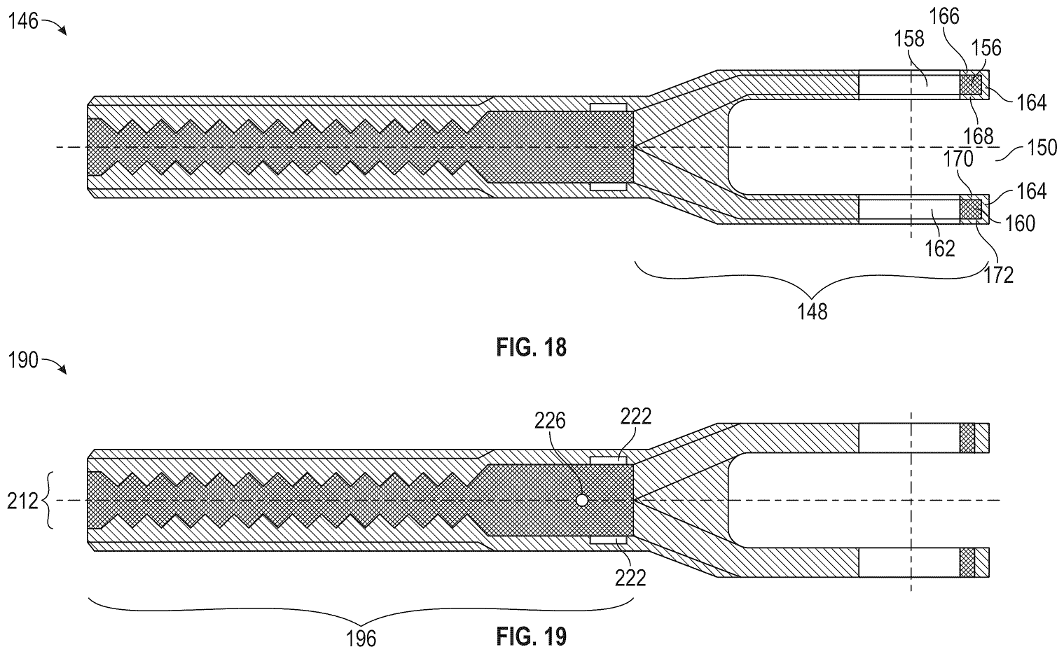

Referring to FIG. 18, a side, cross sectional view of a fifth implementation of a reinforced clevis device 146 is illustrated. The reinforced clevis device 146 may be the same as the reinforced clevis device 34 of FIG. 15, with the only distinction being that the first loop 156 and second loop 160 of the reinforced clevis device is fully encapsulated by a second plastic (which may be a short fiber reinforced, long-fiber reinforce, or unreinforced thermoplastic 164, hereinafter “thermoplastic 164”).

As illustrated by FIG. 18, the reinforced clevis device 146 includes a clevis 148 near a first end 150 of the reinforced clevis device 146. A first loop 156 of continuous fiber reinforced thermoplastic surrounds a portion of a first opening 158 of the clevis 148. A second loop 160 of continuous fiber reinforced thermoplastic surrounds a portion of a second opening 162 of the clevis 148. In various implementations, the first loop 156 may be exposed within the first opening 158 and the second loop 160 may be exposed within the second opening 162. In other implementations, the thermoplastic 164 may cover the portions of the first loop and the second loop that would be exposed within the first opening 158 and the second opening 162.

Still referring to FIG. 18, the thermoplastic 164 surrounds the first loop 156 of continuous fiber reinforced thermoplastic at a first end 150 of the reinforced clevis device 146 and the second loop 160 of continuous fiber reinforced thermoplastic at a first end 150 of the reinforced clevis device 146 to form an outer contour of the clevis. In addition, the thermoplastic 164 of the clevis 148 is coupled around the top 166 and bottom 168 of the first loop 156 of continuous fiber reinforced thermoplastic and coupled around the top 170 and bottom 172 of the second loop 160 of continuous fiber reinforced thermoplastic.

Referring to FIG. 19, a side, cross sectional view of a sixth implementation of a reinforced clevis device 190 is illustrated. The reinforced clevis device 190 may be the same as the reinforced clevis device 34 of FIG. 15, with the only distinction being that the reinforced clevis device 190 includes a locking pin 226.

The reinforced clevis device 190 includes a ring 222 coupled around a first end of the continuous fiber reinforced thermoplastic form fit core 212. The reinforced clevis device 190 includes a locking pin 226 positioned through the stem 196 of the reinforced clevis device 190 near the ring 222. In such implementations, the ring 222 is locked in place as the locking pin 226 prevents the ring 222 from slipping down the stem and the angled loops of the reinforced thermoplastic prevent the ring from slipping over the clevis. Any of the implementations disclosed herein may include a locking pin 226.

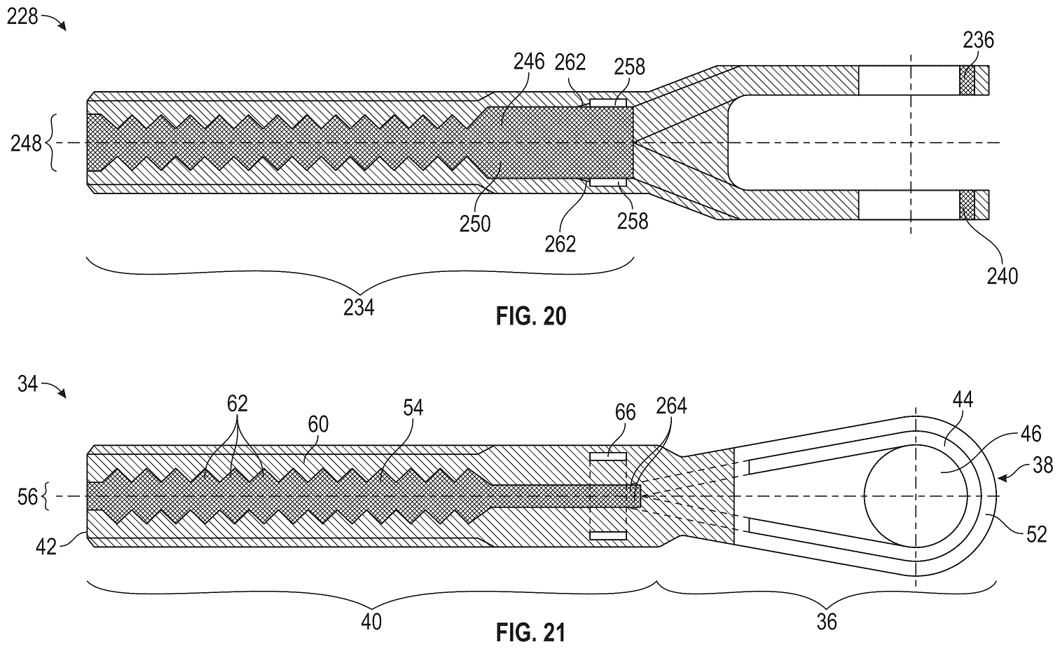

Referring to FIG. 20, a side, cross sectional view of a seventh reinforced clevis device 228 is illustrated. The reinforced clevis device 228 may be the same as the reinforced clevis device 34 of FIG. 15, with the only distinction being that the reinforced clevis device 228 includes locking tabs 262.

Both ends of the first loop 236 of continuous fiber reinforced thermoplastic join to form a first portion 246 of the form fit core 248 that runs through the middle of the stem 234. Both ends of the second loop 240 of continuous fiber reinforced thermoplastic join to form a second portion 250 of the form fit core 248 that runs through the middle of the stem 234.

In various implementations, the continuous fiber reinforced thermoplastic form fit core 248 includes locking tabs 262 that extend away from the form fit core 248 of the stem 234. In such implementations, the ring 258 is locked in place as the locking tabs 262 prevent the ring 258 from slipping down the stem and the angled loops of the reinforced thermoplastic prevent the ring from slipping over the clevis.

In various implementations, the reinforced clevis device includes a plurality of locking tabs. In other implementations, the reinforced clevis device may include a single locking tab. Any of the implementations disclosed herein may include one or more locking tabs 262 configured to secure a ring in place.

In still other implementations, the reinforced clevis device may include a locking mechanism different from the locking pin or locking tabs configured to secure the ring in place over the core while forming the remainder of the reinforced clevis device.

Referring to FIG. 21, a top, cross sectional view of the reinforced clevis device 34 of FIG. 15 is illustrated. As illustrated in FIG. 21, a first loop 44 of continuous fiber reinforced thermoplastic surrounds a portion of a first opening 46 of the clevis 36. A short-fiber reinforced, long-fiber reinforced, or unreinforced thermoplastic 52 surrounds the first loop 44 of continuous fiber reinforced thermoplastic at a first end 38 of the reinforced clevis device 34 and forms an outer contour of the clevis 36. Both ends 264 of the first loop 44 of continuous fiber reinforced thermoplastic join to form a first portion 54 of the form fit core 56 that runs through the middle of the stem. As illustrated, the short-fiber reinforced, long-fiber reinforced, or unreinforced thermoplastic 52 surrounds the form fit core 56 and forms the exterior of the stem 60.

In various implementations, and as illustrated by FIGS. 15 and 21, the portion of the form fit core 56 within the ring 66 may have a height that is greater than a width. In such implementations, the ring 66 may not directly couple to the form fit core along an entirety of the inner perimeter of the ring 66 and portions of the short-fiber reinforced, long-fiber reinforced, or unreinforced thermoplastic 52 may be between the ring 66 and the form fit core 56.

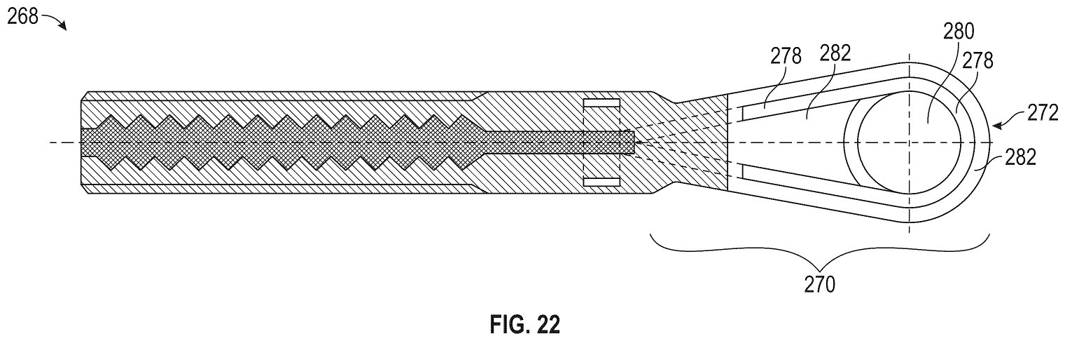

Referring to FIG. 22, a top, cross sectional view of an eighth implementation of a reinforced clevis device 268 is illustrated. The reinforced clevis device 268 illustrated in FIG. 22 may be the same as the reinforced clevis device 34 of FIG. 21, with the only distinction being that the reinforced clevis device 268 includes a first loop 278 of continuous fiber reinforced thermoplastic that surrounds the entire perimeter of a first opening 280.

As illustrated in FIG. 22, the reinforced clevis device 268 includes a clevis 270 near a first end 272 of the of the reinforced clevis device 268. The clevis includes a first loop 278 of continuous fiber reinforced thermoplastic surrounding the entire perimeter of the first opening 280 of the clevis 270. In such implementations, the first loop is exposed along an entire inner perimeter of the first opening 280.

While not illustrated by FIG. 22, the clevis 270 includes a second loop of continuous fiber reinforced thermoplastic surrounds the entire perimeter of a second opening of the clevis 270. In such implementations, the second loop is exposed along an entire inner perimeter of the second opening.

Referring to FIGS. 23-26, various cross sectional views of the continuous fiber reinforced thermoplastic form fit core of a reinforced clevis device are illustrated. These views illustrate the relation between the form fit core and the ring surrounding the core. These form fit cores, along with the surrounding ring, may be integrated into any of the implementations of reinforced clevis devices disclosed herein.

As illustrated, the form fit core may have a variety of cross-sectional shapes, such as, by non-limiting example, a straight strip, a cross, a triangle, a rectangle, a circle, an oval, an “X”, or any other shape. In some implementations, the form fit core may contact the entire interior perimeter of the ring. In other implementations, the form fit core may not be in contact with the entire interior perimeter of the ring.

Referring to FIG. 23, cross sectional view of a first implementation of a stem 300 of a reinforced clevis device is illustrated. The cross sectional view illustrated in FIG. 24 is taken at a first end of the stem 300 where a ring 302 is located. As illustrated in FIG. 24, a ring 302 is coupled around the form fit core 304 made of continuous fiber reinforced thermoplastic and coupled around the short-fiber reinforced, long-fiber reinforced, or unreinforced thermoplastic exterior 306 of the stem 300. The cross section of the form fit core 304 is a strip or is substantially rectangular in shape. A first edge 308 of the form fit core 304 and a second edge 310 end of the form fit core 304 directly opposite the first edge 308 are slightly curved so that they are in direct contact with the interior side of the ring 302. The short-fiber reinforced, long-fiber reinforced, or unreinforced thermoplastic exterior 306 of the stem 300 is in direct contact with the form fit core 304 and in direct contact with the ring 302. The ring 302 may be made of continuous fiber reinforced thermoplastic and the fibers of the ring 302 may be oriented in the circumferential direction of the ring 302. These fibers in the ring 302 may provide support for radial stresses that are created when a first opening of a clevis and a second opening of a clevis are widened and placed under radial stress. The direct contact between the form fit core 304 and the ring 302 allows the ring 302 to directly absorb the radial stress placed on the form fit core 304 and the entirety of the stem 300.

Referring to FIG. 24, cross sectional view of a second implementation of a stem 312 of a reinforced clevis device is illustrated. The cross sectional view of the stem 312 illustrated in FIG. 24 is taken at a first end of the stem 312 where a ring 314 is located. As illustrated in FIG. 24, a ring 314 is coupled around the form fit core 316 made of continuous fiber reinforced thermoplastic and coupled around the short-fiber reinforced, long-fiber reinforced, or unreinforced thermoplastic exterior 318 of the stem 312. The cross section of the form fit core is a strip or is substantially rectangular in shape. A first edge 320 of the form fit core 316 and a second edge 322 of the form fit core 316 directly opposite the first edge 320 are slightly curved so that they are in direct contact with the interior side of the ring 314. The short-fiber reinforced, long-fiber reinforced, or unreinforced thermoplastic exterior 318 of the stem 312 is in direct contact with the form fit core 316 and in direct contact with the ring 314. There is a layer 324 of short-fiber reinforced, long-fiber reinforced, or unreinforced thermoplastic coupled around the exterior perimeter of the ring 314. The ring 314 may be made of continuous fiber reinforced thermoplastic and the fibers of the ring 314 may be oriented in the circumferential direction of the ring 314. These fibers in the ring 314 may provide support for radial stresses that are created when a first opening of a clevis and a second opening of a clevis are widened and placed under radial stress. The direct contact between the form fit core 316 and the ring 314 allows the ring 314 to directly absorb the radial stress placed on the form fit core 316 and the entirety of the stem 312.

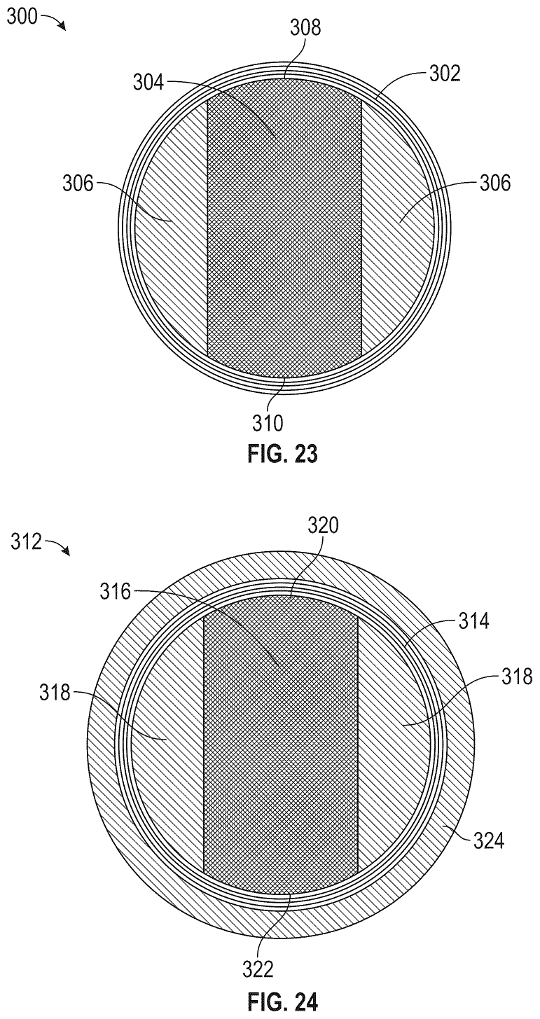

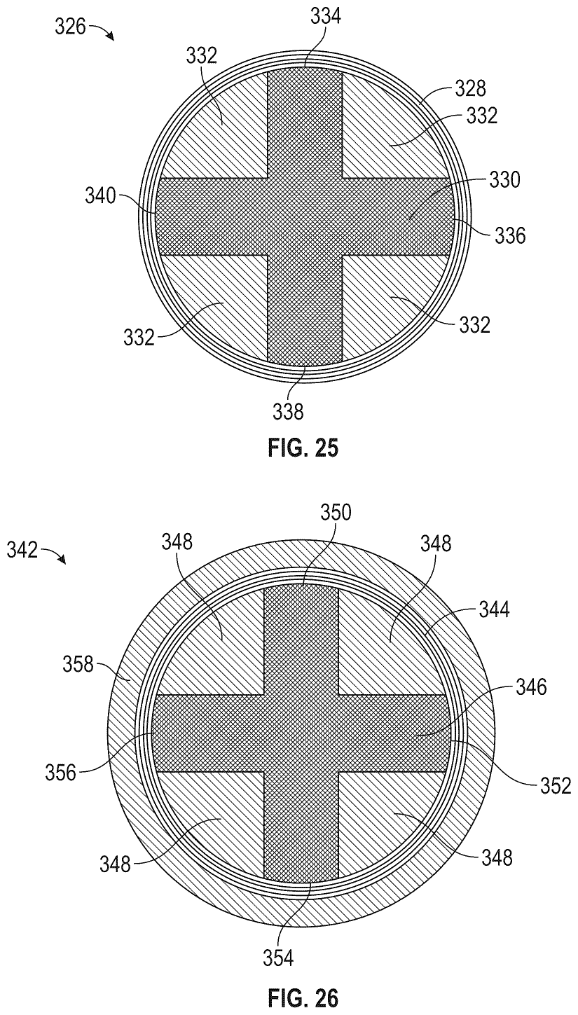

Referring to FIG. 25, a cross sectional view of a third implementation of a stem 326 of a reinforced clevis device is illustrated. The cross sectional view of the stem 326 illustrated in FIG. 25 is taken at a first end of the stem 326 where a ring 328 is located. As illustrated in FIG. 25, a ring 328 is coupled around the form fit core 330 made of continuous fiber reinforced thermoplastic and coupled around the short-fiber reinforced, long-fiber reinforced, or unreinforced thermoplastic exterior 332 of the stem 326. The cross section of the form fit core 330 is a cross shape. The first exterior edge 334, second exterior edge 336, third exterior edge 338, and fourth exterior edge 340 of the cross shape are all slightly curved so that they are in direct contact with the interior side of the ring 328. The short-fiber reinforced, long-fiber reinforced, or unreinforced thermoplastic exterior 332 of the stem 326 is in direct contact with the form fit core 330 and in direct contact with the ring 328. The ring 328 may be made of continuous fiber reinforced thermoplastic and the fibers of the ring 328 may be oriented in the circumferential direction of the ring 328. These fibers in the ring 328 may provide support for radial stresses that are created when a first opening of a clevis and a second opening of a clevis are widened and placed under radial stress. The direct contact between the form fit core 330 and the ring 328 allows the ring 328 to directly absorb the radial stress placed on the form fit core 330 and the entirety of the stem 326.

Referring to FIG. 26, a cross sectional view of a fourth implementation of a stem 342 of a reinforced clevis device is illustrated. The cross sectional view of the stem 342 illustrated in FIG. 26 is taken at a first end of the stem 342 where a ring 344 is located. As illustrated in FIG. 26, a ring 344 is coupled around the form fit core 346 made of continuous fiber reinforced thermoplastic and coupled around the short-fiber reinforced, long-fiber reinforced, or unreinforced thermoplastic exterior 348 of the stem 342. The cross section of the form fit core 346 is a cross shape. The first exterior edge 350, second exterior edge 352, third exterior edge 354, and fourth exterior edge 356 of the cross shape are all slightly curved so that they are in direct contact with the interior side of the ring 344. The short-fiber reinforced, long-fiber reinforced, or unreinforced thermoplastic exterior 348 of the stem 342 is in direct contact with the form fit core 346 and in direct contact with the ring 344. There is a layer 358 of short-fiber reinforced, long-fiber reinforced, or unreinforced thermoplastic coupled around the exterior perimeter of the ring 344. The ring 344 may be made of continuous fiber reinforced thermoplastic and the fibers of the ring 344 may be oriented in the circumferential direction of the ring 344. These fibers in the ring 344 may provide support for radial stresses that are created when a first opening of a clevis and a second opening of a clevis are widened and placed under radial stress. The direct contact between the form fit core 346 and the ring 344 allows the ring 344 to directly absorb the radial stress placed on the form fit core 346 and the entirety of the stem 342.

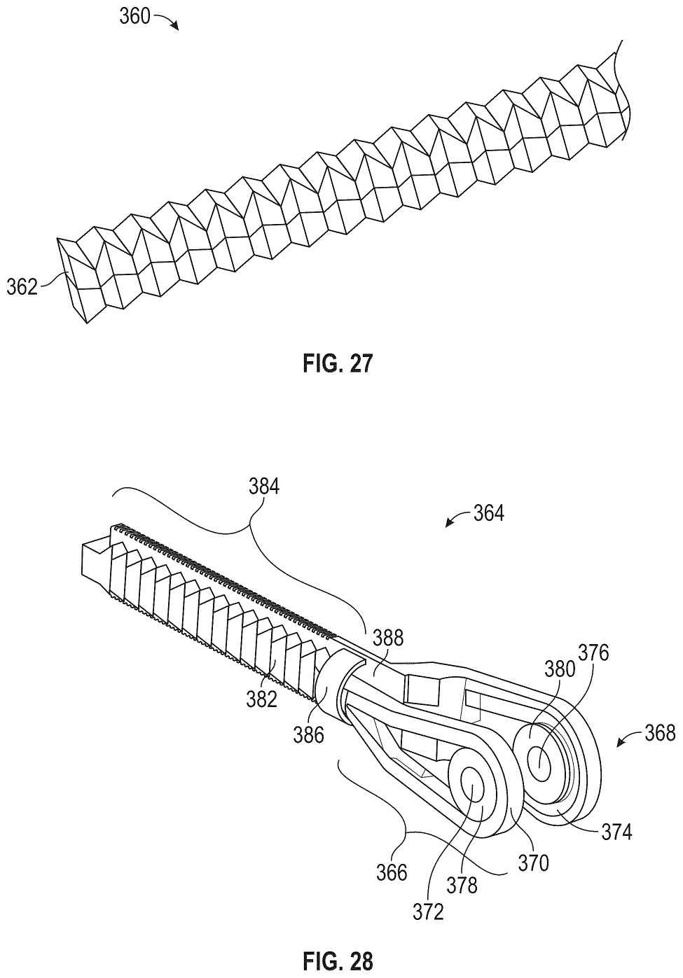

Referring to FIG. 27, a first portion 360 of a continuous fiber reinforced thermoplastic form fit core is illustrated. In various implementations, any of the form fit cores disclosed herein may include form fit core similar to the core of FIG. 27 and include angled projections on all sides of the form fit core.

Referring to FIG. 28, a partial, perspective view of a reinforced clevis device 364 is illustrated. The reinforced clevis device 364 of FIG. 28 is illustrated with the short-fiber reinforced thermoplastic, long-fiber reinforced thermoplastic, or unreinforced thermoplastic portion 388 not coupled over the loop or the first portion of the form fit core for the sake of illustrating the portions of the form fit core normally hidden within stem.

The reinforced clevis device 364 includes a clevis 366 near a first end 368 of the reinforced clevis device 364. A first loop 370 of continuous fiber reinforced thermoplastic surrounds a portion of a first opening 372 of the clevis 366. A second loop 374 of continuous fiber reinforced thermoplastic surrounds a portion of a second opening 376 of the clevis 366. A first bushing 378 is coupled within the first opening 372 of the clevis 366. A second bushing 380 is coupled within the second opening 376 of the clevis 366. Both ends of the first loop 370 of continuous fiber reinforced thermoplastic join to form a first portion 382 of the form fit core that extends into the stem 384.

The first portion 382 of the form fit continuous fiber reinforced thermoplastic core is distinct from a second portion of the form fit continuous fiber reinforced thermoplastic core formed from the second loop 374. A ring 386 is coupled around a first end of the continuous fiber reinforced thermoplastic form fit core. The ring 386 is coupled through a short-fiber reinforced thermoplastic, long-fiber reinforced plastic, or unreinforced plastic portion 388 of the stem 384. The ring 386 is configured to maintain direct contact between the first portion 382 of the core and the second portion of the core during an injection molding process.

While the implementations disclosed herein discuss using thermoplastics reinforced with continuous fibers, any of the plastics disclosed herein may also be reinforced with discontinuous fibers.

A method of forming a reinforced clevis device may include forming a first loop of continuous fiber reinforced thermoplastic. Both ends of the first loop may merge and form a first portion of a core of a stem. In various implementations, the ends may be directly coupled together but not bound together, while in other implementations the ends may be bound together prior to molding over the ends. A second loop of continuous fiber reinforced thermoplastic may be formed. Both ends of the second loop may merge and form a second portion of the core of the stem. In various implementations, the ends may be directly coupled together but not bound together, while in other implementations the ends may be bound together prior to molding over the ends. The first portion and the second portion may be placed in direct contact with each other along the respective contact layers making a core of the stem.

A ring may be formed and placed around the continuous fiber reinforced thermoplastic form fit core at a first end of the stem. The ring will be adjacent to where each portion of the core splits into respective ends of each loop. The ring may be configured to maintain direct contact between the first portion of the core and the second portion of the core during an injection molding process. The ring may be used to hold the different pieces of the core together while also providing additional strength to the reinforced clevis device.

In various implementations, a locking pin may be coupled through the middle of the stem and positioned next to the ring. The pin may be configured to keep the ring stationary during the injection molding process.

In other implementations, one or more locking tabs may be formed that extend away from the core of the stem. The one or more locking tabs may be configured to keep the ring stationary during an injection molding process and prevent the ring from moving towards the rod end.

In still other implementations, the method may include using some other locking mechanism, whether part of the eventual reinforced clevis device or separate from the device, to secure the ring in place while molding over the core.

The continuous fiber reinforced thermoplastic may be pushed into the injection mold to form a remainder of the clevis. The injection molded thermoplastic may be short-fiber reinforced, long-fiber reinforced, or unreinforced thermoplastic. This short-fiber reinforced, long-fiber reinforced, or unreinforced thermoplastic may be formed around the form fit core. In some implementations the form fit core may be exposed through the injection molded thermoplastic at the rod end. In various implementations, the injection molded thermoplastic may cover the entire exterior perimeter of the ring. In other implementations, the exterior perimeter of the ring may be exposed on the surface of the injection molded thermoplastic. The injection molded thermoplastic may be formed around the ends of the first loop of continuous fiber reinforced thermoplastic and the second loop of continuous fiber reinforced thermoplastic to form a first outer contour of the clevis and second outer contour of the clevis, respectively. The injection mold may include threads along the interior perimeter of the injection mold cavity so that corresponding threads are formed on the exterior perimeter of the stem. In other implementations, the exterior of the stem may be smooth. In various implementations, the method may include coupling a first bushing within the first opening of the clevis and coupling a second busing within the second opening of the clevis.

In places where the description above refers to particular implementations of clevises and implementing components, sub-components, methods and sub-methods, it should be readily apparent that a number of modifications may be made without departing from the spirit thereof and that these implementations, implementing components, sub-components, methods and sub-methods may be applied to other clevises.

What is claimed is:

1. A clevis comprising:
a continuous fiber reinforced thermoplastic at least partially looped around a first opening in the clevis and a second opening in the clevis; and
a stem;
wherein the continuous fiber reinforced thermoplastic extends into the stem.

2. The clevis of claim 1, wherein the continuous fiber reinforced thermoplastic comprises a first portion that extends into the stem and a second portion that extends into the stem, wherein the first portion is directly coupled to and distinct from the second portion.

3. The clevis of claim 1, wherein a cross section of the continuous fiber reinforced thermoplastic in the stem forms a cross.

4. The clevis of claim 1, wherein a cross section of the continuous fiber reinforced thermoplastic in the stem forms a square.

5. The clevis of claim 1, further comprising a continuous-fiber reinforced thermoplastic ring encircling the continuous fiber reinforced thermoplastic.

6. The clevis of claim 5, wherein the continuous-fiber reinforced thermoplastic ring contacts the continuous fiber reinforced thermoplastic.

7. The clevis of claim 5, further comprising a second plastic encircling the continuous-fiber reinforced ring.

8. The clevis of claim 5, wherein the continuous-fiber reinforced thermoplastic ring is coupled around an outer surface of the stem.

9. A clevis comprising:
a first opening;
a second opening;
a fiber reinforced plastic at least partially looped around the first opening and the second opening;
a stem; and
a ring encircling a portion of the fiber reinforced plastic that extends into the stem.

10. The clevis of claim 9, further comprising a second plastic surrounding the fiber reinforced plastic, wherein the second plastic forms an outer surface of the clevis.

11. The clevis of claim 10, wherein the second plastic encapsulates the ring.

12. The clevis of claim 10, wherein the ring is coupled around an outer surface of the stem.

13. The clevis of claim 9, wherein the ring is a continuous-fiber reinforced thermoplastic ring comprising fibers oriented in a circumferential direction.

14. The clevis of claim 9, wherein the ring contacts the fiber reinforced plastic.

15. The clevis of claim 9, wherein the continuous-fiber reinforced thermoplastic is exposed within the first opening and the second opening.

16. A clevis comprising:
a first opening;
a second opening;
a first fiber reinforced plastic at least partially looped around the first opening and extending into a stem of the clevis;
a second fiber reinforced plastic at least partially looped around the second opening and extending into the stem of the clevis;
wherein the first fiber reinforced plastic is distinct from the second fiber reinforced plastic and is directly coupled to the second reinforced plastic.

17. The clevis of claim 16, further comprising a ring coupled to the stem and encircling the first fiber reinforced plastic and the second fiber reinforced plastic.

18. The clevis of claim 17, wherein the ring is exposed on an outer surface of the clevis.

19. The clevis of claim 17, wherein the ring is directly coupled to the first fiber reinforced first plastic and the second fiber reinforced plastic.

20. The clevis of claim 16, further comprising a locking pin coupled to the stem.
